(19) United States
(12) Patent Application Publication
(10) Pub. No.: US 2003/0118713 A1
(43) Pub. Date: Jun. 26, 2003

(54) Nutritional drink

(76) Inventors: Jane Bjorkstrom, Stockholm (SE); Goran Bodemar, Stockholm (SE); Gusta Lindewald, Stockholm (SE); Lars-Borje Sjoberg, Stockholm (SE)

Correspondence Address: LARSON & TAYLOR, PLC, 1199 NORTH FAIRFAX STREET, SUITE 900, ALEXANDRIA, VA, 22314, US

(21) Appl. No.: 10/169,910

(22) PCT Filed: Jan. 10, 2001
(86) PCT No.: PCT/SE01/00034

(30) Foreign Application Priority Data
Jan. 12, 2000 (SE) 0000073-7

(51) Int. Cl. A23L 2/38

(52) U.S. Cl. 426/598

(57) ABSTRACT

Nutritional drink which can with good tolerance be taken by persons suffering from feeling of nausea, or which are expected to be sick when consuming food or drink, which nutritional drink have an energy value of not more than 85, or preferably 40-60 kcal/100 ml drink, and an osmolality of not more than 600, or preferably 350-400 mOsmol/kg water, and which mainly contains proteins in an amount of 0.5-5.0 g/100 ml drink, carbohydrates in an amount of 6-20 g/100 ml drink, salts and acidifying agents that give a pH-value in the final drink of between 3 and 6, aroma, flavouring agents and vitamins.

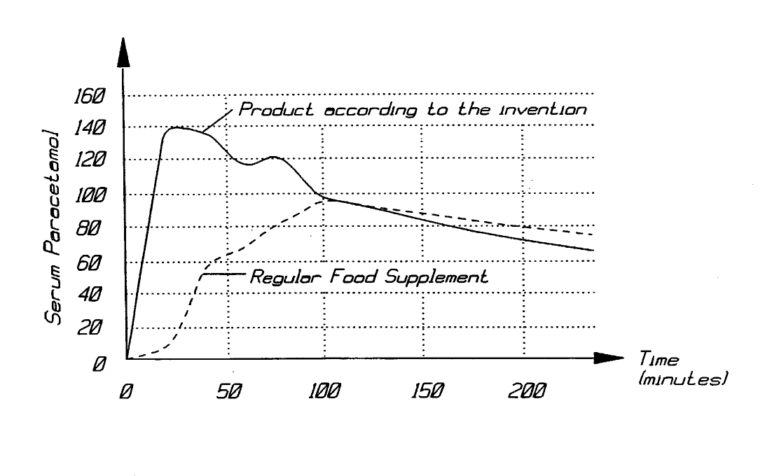

This invention pertains to a nutritional drink which with good tolerance can be ingested by persons suffering from nausea, or which are expected to be sick when consuming food or drink, e.g. persons who are treated with composition which can cause nausea, such as cytostatics, or persons who have become sick after consuming a certain type of food or drink, or persons who have been submitted to some form of surgical operation including anaesthesia, analgesia or narcosis, or persons in general who by different reasons easily get nauseous. It is important that patients get enough nutrition. The drink is clear and contains mainly proteins, carbohydrates, salts, acidifying agents, aroma, flavouring agents and vitamins.

At chronic diseases the appetite often decreases, and if you are also nauseous, the nutritional intake is even more difficult. At nausea the nutritional intake from regular food is to small and leads to loss of weight and muscular mass. Malnutrition and loss of muscular strength and thus decreased general well-being, leads to decreased tolerance to treatments, e.g. radiotherapy and treatment with cytotoxic drugs at tumoural diseases, but also the result of the treatment itself is reduced. This is especially obvious after surgical operations if you are malnourished before the operation. Earlier, administration of nutrition by injecting into the blood stream, so called intravenous nutrition, was used to ameliorate the nutritional condition and to increase the muscular strength at severe diseases. Nowadays, it is known that, if nutrition can instead be administered in regular ways or through enteral probe nutrition to the stomach and the intestines, the administration of nutrition is tolerated better and the ability of the body to assimilate the nutrition is facilitated.

It is not fully understood which mechanisms lead to nausea and low tolerance towards ingested food. It is however known that at nausea food and drink remain in the stomach a prolonged time, or reversed, that nausea makes food and drink remain in the stomach a prolonged time. When food and drink remain in the stomach a prolonged time often a feeling of uneasiness occurs with nausea as a consequence.

Patients who due to nausea can not ingest regular food are often offered lemonade and water. The lemonade has very little nutritional content, but is nevertheless often poorly tolerated by many patients. Known complete nutritional supplements can for different reasons exhibit poor acceptance. They often have such a high viscosity that they are difficult to drink, they can also have a cloudy appearance, something which is considered unpleasant by the patient. They also often contain a certain amount of fat, which gives a relatively slow drainage of the stomach and thus poor tolerance towards nausea.

It is thus desirable that a drink according to the present invention, to prevent or to reduce nausea, shall leave the stomach relatively fast. For all that, the drink should have good energy density and such a osmolality, and should besides that be of such nature, that the drink leaves the stomach relatively fast and that it at the same time provides a reasonable amount of energy and of suitable nutritional components.

Drinks are known that are designed to constitute a complete nutritional supplement containing proteins, fat, carbohydrates and suitable flavouring agents, as from citrus fruits, different types of fruits and berries, chocolate, vanilla or synthetic aroma etc. These known nutritional supplements have a energy density of approximately 100-200 kcal per 100 ml, and they have a osmolality of as much as 800. The drinks do give nutrition, but can due to their high energy density and thus even higher osmolality lead to nausea, or even make the nausea worse and cause vomiting. This is believed to be due to too slow draining of the stomach, and that the drinks are therefore not suitable for sick persons or persons that can easily get sick when consuming food.

There are also light drinks, which in fact can be tolerated by sick persons, but such drinks lack the sufficient amount of nutritional components and essential additives of salt, minerals and vitamins, etc.

A drink according to the invention should be well tolerated by persons suffering from nausea and have a relatively low osmolality and a “reasonable” energy value. Preferably, the drink should be clear and have a fat content as low as possible. An important feature of the drink according to the present invention is that it should have the ability to quench thirst, and at the same time provide a reasonable amount of nutrition, something which is hardly obtained with said previously known nutritional supplements. This is possible because the product is given a composition such that it contains quite a moderate energy density, in particular an energy density that does not exceed 85 kcal/100 ml drink.

The drink according to the present invention should have such a balanced composition of proteins, carbohydrates and minerals that it is well tolerated even by severely malnourished patients, i.e. that the risk of diseases caused by the administration of the nutrition itself, so called refeeding syndrome, can be prevented.

Osmolality

The osmolality of the drink should not allowed to exceed 600 and can suitably be 400 mOsmol./kg water or less. A suitable osmolality can be between 300 and 600 mOsmol/kg water. The energy value, which is related to the osmolality, can be allowed to be 85 kcal/100 ml drink, but should preferably be 40-60 kcal/100 ml and can be constituted by:

protein in an amount of 0.5-5 g or preferably 1.5-3 g/100 ml drink

carbohydrates in an amount of 6-20 g/100 ml drink

minerals and salts in balanced amounts

acidifying agent which gives a pH-value of 3-6 in order to make the product stable.

The different ingredients in the drink according to the invention each contribute to the osmolality, which can be exemplified by the following example:

Contribution from different nutritional
components to the osmolality of the drink

| | |
|---|---|
| Proteins | 12.5% |
| Carbohydrates | 62.5% |
| Minerals, acidifying agents | 25% |
| Total | 100% |

Energy Value

The energy value of the drink can be allowed to amount to 85 kcal per 100 ml drink, but should preferably be between 40 to 60 kcal per 100 ml drink. The energy value is linked to the osmolality, and an energy value of 85 kcal per 100 ml drink can give an osmolality of nearly 600 mOsmol/kg water, which is the upper limit for osmolality depending on the composition of carbohydrates. An energy value above 85 kcal per 100 ml drink gives too high osmolality, if the demands for clarity and low viscosity are maintained, and thus a relatively slow draining of the stomach, which is important for the ability of the patient to tolerate the drink; an energy value of less than 40 kcal per 100 ml drink gives an unsatisfactory low intake of energy. The demand for good tolerance require in turn that the drink should be clear, have low viscosity and suitable sweetness. The drink must according to the posed demands be free of fat.

Protein

Protein should according to nutritional recommendations be present in such an amount that they provide for 10-20% of the energy intake. At very low intake of energy the protein need can be relatively greater. 1 g protein/100 ml drink gives approximately 8% of the energy intake, 2 g gives approximately 16% and gives approximately 24%. As far as possible it is important to satisfy the protein need, since patients often have a negative nitrogen balance (N-balance).

The protein content should be 0.5-5% or preferably 1.5-3%. The protein source can be defatted whey protein with a fat content of less than 0.2%, which protein is not decomposed and gives a clear solution with neutral taste. It is also possible to use hydrolysed protein or a blend of intact and hydrolysed protein. Too high a protein content increases the risk of gel forming in the drink. When using only intact protein, the protein content should not exceed 4%. When using only hydrolysed protein the protein content can be allowed to be somewhat higher, amounting to 5%. Hydrolysed protein can occasionally be considered as giving a somewhat bitter taste, and it is therefore recommended that the drink contains at least a certain amount of intact protein.

As alternative sources of protein one can mention other types of milk protein, soy protein with low fat content, rice, peas, beans and other known protein sources, which proteins can all be intact or hydrolysed.

Carbohydrates

The content of carbohydrates should be between 6 to 20 g per 100 ml drink. A carbohydrate content higher than 20 g/100 ml drink, having at the same time low viscosity and a suitable sweetness, can give an osmolality of 600 mOsmol or more. The carbohydrate content should therefore not exceed this limit. A carbohydrate content lower than 6 g/100 ml drink gives an energy value which is considered too low for a drink of this kind. Saccharose, maltodextrin, glucose, glucose syrup, fructose, fructose syrup, starch and other known carbohydrate sources can be used as carbohydrate source. A blend of saccharose, glucose syrup and maltodextrin is preferable.

Minerals and Salts

When one under starvation conditions administers nutritional supplements, such as sugar and protein, it is at the same time necessary to make sure that some important minerals are present, for the metabolism of the nutrition and to avoid development of so called refeeding syndrome, which will mean extra low cellular levels of phosphorus, potassium and magnesium. The most important electrolytes for the drink are phosphorus, potassium, magnesium and sodium. Minerals like calcium, magnesium, iron and zinc are also important. Sodium can be present in a content of 30-50 mg/100 ml drink. A certain amount of sodium is needed for the transport of glucose through the bowel wall. A content of more than 50 mg gives lower acceptance due to inferior taste. The content of phosphorus is related to the content of glucose in the drink, but should be 35-70 mg/100 ml drink.

The drink should contain so much potassium, phosphorus and magnesium that, if protein is to be administered to severely undernourished patients, 30 mmols of potassium, 2.3 mmols of magnesium and 20 mmols of phosphorus is needed per 10 g of nitrogen. At “refeeding” 20 mmols of phosphorus are required per 250 g of glucose given intravenously, if the organism is suffering from phosphorus defiency at the start of the nutritional treatment.

10 g nitrogen corresponds to 62.5 g protein, i.e. 1 g protein gives 0.16 g nitrogen. A drink according to the invention containing 20 g protein can according to calculations suitably contain 17 mmols/l sodium, at least 6 mmols/l potassium, 2 mmols/l magnesium and 11 mmols/l phosphorus. The potassium content could be increased to 18 mmols/l potassium, but then should at the same time the content of phosphorus also be increased.

Phosphorus

Under starvation conditions the need for phosphorus is lower than normally since the dominating fuel source of the body is fat. When carbohydrates are given orally, enterally or parenterally, the extracellular phosphorus can decrease rapidly and lead to hypophosphatemia, unless phosphorus is administered at the same time. To make added protein usuable for development of new tissue, addition of phosphorus is also needed. The daily need for phosphorus is 0.3 mmols of potassium phosphate per kg body weight, corresponding to 20 mmols per litre phosphate. It is important that the product, in proportion to its content of carbohydrates and protein, contains a suitable amount of phosphorus. The content of phosphorus can be 2-20 mmols/l.

Sodium

When carbohydrates (glucose) are administered insulin is released, and thus the need for sodium increases. Normally, the supply of sodium in the body is sufficient, but under starvation the supplies might be empty.

Thiamine

The addition of thiamine is important for the metabolism of carbohydrates. When protein is administered under starvation conditions the protein synthesis is increased, but it is not likely that added protein can be stored in the body.

It is important that the product in its composition of energy and minerals in the best way facilitates the usage of the added protein in protein synthesis.

Potassium

The content of potassium can be 3-20 mmols potassium per litre.

Magnesium

The content of magnesium can be 0.5-5 mmols potassium per litre.

Minerals can be required to take care of the nutrition provided by carbohydrates and proteins when the patient is in an anabolic state. A drink according to the invention can suitably contain:

Mineral composition

| | Molecular | | | Interval | | | | Total |
|---|---|---|---|---|---|---|---|---|
| | weight | mg/100 | | mg/ | Interval | Desired increase | | 20 g prot./l |
| Salt | g/mol) | ml | mmols/l | 100 ml | mmol/l | mg/100 ml | mmols/l | 70 g gluc. |
| Sodium | 23 | 40 | 17 | | | | | |
| Potassium | 39 | 25 | 6 | ”12-78 | ”3-20 | 39 | 10 | 10 |
| Magnesium | 24 | 5 | 2 | ”1-12 | ”0,5-5 | | | 0,8 |
| Calcium | 40 | 30 | 8 | | | | | |
| Phosphorus | 31 | 35 | 11 | ”6-62 | ”2-20 | | | 12 |

The Protein Need for Minerals

10 g nitrogen corresponds to 62.5 g protein (63.8 g whey protein)

1 g protein corresponds to 0.16 g nitrogen

The drink contains 20 g protein per litre

The drink contains 3.2 g nitrogen per litre

| | Molecular | Per 10 g | Per 10 g | Per 3,2 g | Per 3,2 g |
|---|---|---|---|---|---|
| | weight | nitrogen | nitrogen | nitrogen | nitrogen |
| Mineral | g/mol | mg/100 ml | mmols/l | mg/100 ml | mmols/l |
| Sodium | 23 | | | | |
| Potassium | 39 | 117 | 30 | 39 | 10 |
| Magnesium | 24 | 6 | 2,5 | 1,9 | 0,8 |
| Calcium | 40 | | | | |
| Phosphorus | 31 | 62 | 20 | 19 | 6 |

The Carbohydrate Need for Minerals

1 mole saccharose give 1 mole glucose och 1 mole fructose

The drink contains 70 g saccharose per litre

The drink contains 70 g glucose per litre

| | Molecular | | | | |
|---|---|---|---|---|---|
| | weight | Per 250 g glucose | | Per 70 g glucose | |
| Mineral | g/mol | mg/100 ml | mmols/l | mg/100 ml | mmols/l |
| Sodium | 23 | | | | |
| Potassium | 39 | | | | |
| Magnesium | 24 | | | | |
| Calcium | 40 | | | | |
| Phosphorus | 31 | 62 | 20 | 19 | 6 |

Acidifying and Flavouring Agents

It has been concluded that a certain acidity of the product makes it more easily tolerated, and for that reason the drink can contain some acids. The acidifying agent is chosen from lactic acid, citric acid, phosphoric acid and/or fruit juices or a combination of acids and/or fruit juices. The product can also contain other flavouring agents which can be expected to make it easily tolerated. The pH-value should be within the sour limit and can be chosen between pH 3 and 6, but is preferably between pH 3.2 and 5, or more preferably between pH 3.2 and 3.7.

Composition of the Drink According to the Present Invention

A drink according to the present invention can have the following composition.

Declared nutritional values
Recalculated to biological values

| | | Studied | | | |
|---|---|---|---|---|---|
| | | product | | | |
| | | 1999 | | | |
| | Molecular | Declared | | Declared | |
| | weight | Invention | Invention | Invention | Invention |
| | g/mol | g/mols | mmols/l | mg/100 ml | mmols/l |
| Energy | | 50,0 | | 50,0 | |
| Protein | | 2,0 | | 2,0 | |
| Carbo- | | 10,0 | | 10,0 | |
| hydrates | | | | | |
| | | mg/100 ml | | mg/100 ml | |
| Sodium | 23 | 40 | 17 | 40 | 17 |
| Potassium | 39 | 25 | 6 | 75 | 19 |
| Magnesium | 24 | 5 | 0,2 | 5 | 0,2 |
| Calcium | 40 | 30 | 8 | 30 | 8 |
| Phosphorus | 31 | 35 | 11 | 35 | 11 |
| Chloride | 35 | 80 | 23 | 80 | 23 |

Nutritional value of the drink:

When consuming 1 litre drink per day the following nutritional value is obtained:

Protein 20 g, which give 3.2 g N

Carbohydrate 10 g, of which approximately 70 g is glucose

According to the invention it is utmost importance that the product is quickly emptied from the stomach in order that the product should have a good acceptance by patients who, for various reasons, suffer from indisposition of the type nausea and therefore have difficulties in taking food.

For determining how quickly the products is emptied from the stomach a clinical study has been made among healthy test persons.

Said test persons were given a predetermined amount of the test product on empty stomach, and on another occasion they were given a corresponding amount of a standard liquid food supplement. The emptying of the stomach was checked in that the product was completed by a predetermined amount of paracetamol. The concentration of the paracetamol in plasma was thereafter measured at various times after the drink had been consumed. The use of paracetamol is an established method of following the emptying of the stomach from drinks, and the method is described for instance in J. Gastroenterol 1998; 33:785-791 “Guide for judicious use of paracetamol absorption technique in a study of gastric emptying rate of liquids” by M. Sanaka et al.

The test product used in the test according to the invention contained, per 100 ml:

50 kcal, 2 g wheyprotein, 10 g carbohydrates, vitamins and minerals, osmolality=400.

The Regular Food Supplement contained, per 100 ml:

120 kcal, 5 g milk protein, 4 g fat, vitamins and minerals, osmolality=650.

The diagram given in the accompanying drawings shows a typical plot of paracetamol concentration in plasma after intake of a product according to the invention in comparison with a standard food supplement. The diagram shows a much more rapid increase of paracetamol in plasma after intake of the product according to the invention as compared with the standard Food Supplement. This shows that the product according to the invention is cleared much faster from the stomach that that of the Regular Food Supplement.

The following is a diagram showing the result of the tests:

Serum paracetamol
minutes after meal intake

| | | Minutes | | | | | |
|---|---|---|---|---|---|---|---|
| | 0 | 20 | 40 | 60 | 80 | 100 | 120 |
| Invention | 0 | 133 | 137 | 118 | 120 | 97 | 91 |
| R F Suppl. | 0 | 11 | 54 | 67 | 82 | 94 | 91 |
| Mean val. | 0 | 72 | 95.5 | 92.5 | 101 | 95.5 | 91 |

### EXAMPLE 1

### Defatted Whey Proteins

A drink suitable for intake with expected good tolerance by oncology patients was produced by defatted whey proteins in a content of 2 g/100 ml drink, saccharose combined with maltodextrin 10 g/100 ml drink, with a balanced amount of salts, including sodium, potassium and phosphorus, and citric acid rendering a pH-value of 3.5.

The product had an energy value of 50 kcal/100 ml drink and an osmolality of 400 mOsmol per kilo water. The drink had a content of protein of 2 g/100 ml drink and of carbohydrates of 10 g/100 ml drink.

The drink was tested on 36 oncology and 45 postoperative patients and proved to be well tolerated by 9 of these. The drink provided for a good nutritional supplement. 92-98% of the postoperative patients seemed to tolerate the drink well. 48-71% of the sick oncology patients could drink 1 litre drink per 24 hours, or more.

### EXAMPLE 2

### Defatted Whey Proteins

A drink was produced in the same way as in example 1, but with a carbohydrate content of 21 g/100 ml drink. The energy value was 94 kcal/100 ml drink. The osmolality in this case was 650. The relatively high osmolality made the drink unacceptably unclear. The viscosity was slightly higher than in example 1. The taste was found a bit too sweet. The drink was not tolerated as well as the drink in example 1, mainly because the osmolality was too high, which made the drink difficult to drink.

### EXAMPLE 3

### Defatted Whey Proteins

A drink was produced in the same way as in example 1, but with an energy value of 95 kcal/100 ml drink and containing 2 g protein and 17 g carbohydrates per 100 ml drink, constituted by 10.5 g maltodextrin and 6.5 g saccharose. The osmolality was 565 mOsmol/kg water, which was lower than in example 2, which was due to another composition of carbohydrates.

The energy value was slightly too high for the drink to be desirably tolerated.

### EXAMPLE 4

### Defatted Whey Proteins

The same type of drink that was produced in example 3 was produced by 2 g defatted whey proteins per 100 ml drink and 13.5 g carbohydrates per 100 ml drink, deriving from 7 g maltodextrin and 6.5 saccharose. The energy value of the drink was 63 kcal/100 ml drink and the osmolality of the same was 442 mOsmol/kg water.

The drink was nearly as well tolerated as the drink in example 1.

### EXAMPLE 5

### Hydrolysed Whey Proteins, pH=5.9

A drink was produced in the same way as in example 1, but with the exception that the protein source was constituted by hydrolysed whey proteins. The protein content was 5%. The pH-value was 5.9, near neutral. The osmolality was 435 mOsmol/kg water.

The product was not tolerated as well as the corresponding product containing intact protein. The taste was found flat, not fresh and with a strong bitter after-taste.

### EXAMPLE 6

### Hydrolysed Whey Proteins, pH=4.0

The same drink was produced as was produced in example 5, but with a pH-value of 4.0. The osmolality was 440 mOsmol/kg water.

The drink was found slightly too sour and with a slightly too bitter after-taste.

The examples 5 and 6 show that the osmolality when using hydrolysed whey proteins is higher than 400. At neutral pH-value the taste is not acceptable, but at sour pH-value some patients would possibly accept the drink. The pH-values in the examples 1-4 was set to about 3.5, which would normally be considered as giving a extremely sour drink when using hydrolysed whey proteins as protein source.

### EXAMPLE 7

### Energy Value, 40-80 kcal/100 ml Drink

To determine the osmolality at different energy contents in the drink, a number of low viscosity drinks with suitable sweetness and varying protein and carbohydrate contents was produced. The results are shown in the table below:

| Energy content | Osmolality | Acceptance |
|---|---|---|
| kcal/100 ml | mOsmol/kg water | scale 1-5 |
| <40 | 300 | 1 |
| 50 | 380 | 3 |
| 60 | 430 | 5 |
| 70 | 500 | 5 |
| 80 | 570 | 3 |
| 90 | 620 | 0 |

The table shows that the osmolality is nearly linearly correlated to the energy value of the drink, and that the osmolality increases from <300 mOsmol/kg water at an energy value of approximately 40 kcal/100 ml drink to approximately 650 mOsmol/kg water at an energy value of approximately 95 kcal/100 ml drink.

### EXAMPLE 8

### Varying Osmolality, <600 mOsmol/kg Water

To determine the lower limit for the osmolality, several different drinks with varying osmolality was produced. The drinks had en energy value of 50 kcal/100 ml drink, a protein content of 2 g/100 ml drink and a carbohydrate content of 10 g/100 ml drink. The DE-value of the maltodextrin varied between <10 and <20. The osmolality varied between 145 and 208 mOsmol/kg water.

At an osmolality of 145 mOsmol/kg water the consistency was acceptable, but the drink was slightly cloudy, had no taste of aroma and was found sour. At an osmolality of 208 mOsmol/kg water the consistency was also acceptable, but the drink was very cloudy and had a sour taste. At higher osmolality the drink got better properties for its purpose.

It was found that drinks with an osmolality below 300 mOsmol/kg water get cloudy, and that they lack tasteful sweetness, which makes the drinks taste sour and makes them less tolerated, because the aroma does not come forward.

### EXAMPLE 9

### Varying Protein Content, 0.5-5.0 g/100 ml Drink

In a way corresponding to that of example 8, a suitable protein content was determined by producing a number of different drinks with protein contents varying between 0.5 and 5.0 defatted whey protein/100 ml drink.

At the mentioned lower limit of protein, 11.5 g carbohydrates/100 ml drink was added, of which 6.5 g was saccharose. The osmolality was 378 mOsmol/kg water. The drink had an acceptable consistency, a light yellow colour and a good taste. As the protein content was increased the colour became more and more dark yellow, and the taste got more and more sour due to the fact that a greater amount of acid had to be added to compensate for the buffering properties of the protein. A lower protein content gives a too small nutritional supplement. At a protein content of 5.0 g/100 ml drink the drink was found too sour, and it got an unacceptable taste. To reduce the sourness at high contents of protein more sweetness is required, but this could in turn lead to a unacceptably high osmolality. It could therefore be concluded that the protein value should not be lower than 0.5 g/100 ml drink and not higher than 5 g/00 ml drink.

### EXAMPLE 10

### Varying Carbohydrate Content, 6-20 g/100 ml Drink

A number of different drinks, all with approximately 2 g protein/100 ml drink, were produced, wherein the carbohydrate content was varied between 6 and 20 g/100 ml drink, of which 6.5 g was saccharose.

An osmolality of 378 mOsmol/kg water was found in a drink containing carbohydrate in an amount of 6 g/100 ml drink. The drink had an acceptable consistency and taste. However, the taste was found slightly sour.

As the carbohydrate content was increased the osmolality increased, and at a content higher than 20 g/100 ml drink the drink got a cloudy appearance and a higher viscosity than at a lower carbohydrate content. The osmolality was 512 mOsmol/kg water. The taste was acceptable but was found slightly sweet.

It could therefore be concluded that it is difficult to vary the carbohydrate content within any greater limits. At a low carbohydrate content the taste is less acceptable, and at a high content the drink gets cloudy and can get too high osmolality.

### EXAMPLE 11

### Addition of Salts

The drink according to the invention should contain a “balanced” content of salts, e.g. at a pH-value of 3-6. At a high content of salt the osmolality increases, and more acidifying agents are required to lower the pH-value. This means that the drink gets a more sour taste.

When doubling the total content of salt from 0.25% the osmolality was 469 mOsmol/kg water.

The consistency was acceptable but the drink got a cloudy appearance and the taste was found too sour.

### EXAMPLE 12

### Addition of Acidifying Agent

Several different drinks containing different types of acidifying agent were produced. Citric acid, lactic acid and malic acid worked as suitable acidifying agents. Less suitable acidifying agents are hydrochloric acid, which gives the drink a flat taste, and phosphoric acid which gives the drink a total phosphorus value that is too high.

### EXAMPLE 13

### Addition of Aroma and Fruit Juices

Tests with different aroma using a drink according to the example 1 showed that fruit and berry aroma gave good results, in particular citrus and tropical fruits aroma. Popular aroma like strawberry, vanilla and chocolate do not cover taste from protein and salts sufficiently and are thus less suitable.

### EXAMPLE 14

### Varying Content of Sodium 10-70 mg/100 ml Drink

A drink containing sodium varying from 10 to 70 mg/100 ml drink was produced. The lower limit was set to 10 mg/100 ml drink, as a content of sodium lower than that is unsuitable considering that a certain amount of sodium is necessary for the glucose transport. At such a high sodium content as 70 mg/100 ml drink (corresponding to 30 mmols/l) the drink got cloudy and the taste slightly too salty. The osmolality was measured to 424 mOsmol/kg water, which lies above the suitable level.

### EXAMPLE 15

### Varying Content of Potassium, 20-37 mg/100 ml Drink

A number of test drinks containing potassium varying from 20 to 40 mg/100 ml drink were produced. The drink was found to be cloudy. A certain amount of potassium is necessary, and therefore the lower limit was set to 20 mg/100 ml drink. At a potassium content of 37 mg/100 ml drink (corresponding to 10 mmols/l) the drink started to became cloudy and it could therefore be concluded that the upper limit for addition of potassium should be set at 37 mg/100 ml drink.

### EXAMPLE 16

### Varying Content of Phosphorus, 40-60 mg/100 ml Drink

A number of experiments on addition of phosphorus were made. At a phosphorus content of 60 mg/100 ml drink (corresponding to 9 mmols/l) the drink was very well accepted. The drink was clear and had a fresh, good taste. However, the osmolality got slightly too high, 410 mOsmol/kg water. If this product shall fall under FSMP-products (Food for Special Medical Purposes) this is hindered by a too high phosphorus content.

Summary of examples

| | Energy | | | | | | |
|---|---|---|---|---|---|---|---|
| | kcal/ | Osmolality | Protein | | Carbohydrates | Acceptance | Varying |
| Ex. | 100 ml | mOsmol/kg water | g/100 ml | pH | g/100 ml | scale 1-10 | the content of |
| 1 | 50 | 400 | 2 | 3,5 | 10 | 9 | — |
| 2 | 94 | 650 | 2 | 3,5 | 21 | 3 | — |
| 3 | 78 | 565 | 2 | 3,5 | 17 | 4 | — |
| 4 | 63 | 442 | 2 | 3,5 | 13,5 | 5 | — |
| 5 | 50 | 436 | 2 | 5,9 | 10 | 2 | — |
| 6 | 50 | 440 | 2 | 4 | 10 | 6 | — |
| 7 | 40-80 | >500 | 2 | 3,5 | 8-18 | 8-6 | — |
| 8 | <50 | 145-600 | 2 | 3,5 | 10 | 1-3 | — |
| 9 | 50 | 400 | 0,5-5,0 | 3,5 | 7-12 | 9-5 | — |
| 10 | 41-90 | 361-512 | 2 | 3,5 | 8-20 | 7-5 | — |
| 11 | 50 | 400-464 | 2 | 3-6 | 10 | 4 | salts |
| 12 | 50 | 400 | 2 | 3.5 | 10 | 8-10 | acidification |
| 13 | 50 | 400 | 2 | 3.5 | 10 | 8-10 | aroma/juice |
| 14 | 50 | 425 | 2 | 3.5 | 10 | 2 | sodium |
| 15 | 50 | 389 | 2 | 3.5 | 10 | 3 | potassium |
| 16 | 50 | 410 | 2 | 3.5 | 10 | 8 | phosphorus |

The examples above show that a drink according to the invention should exhibit:

Energy value<85 (preferably 40-60)

Osmolality<600 (preferably 300-600)

Protein 0.5-5 mg/100 ml drink

Carbohydrates 6-20 mg/100 ml drink

Different types of salts and acidifying agents that give a pH-value of 3-6, or preferably 3.2-3.7.

Different acidifying agents and aroma

1. A nutritional drink which can be ingested, with good tolerance, by persons suffering from nausea, or who are expected to be sick when consuming food or drinks, e.g. persons who are treated with compositions which can cause nausea, such as cytostatics, or persons who have become sick after consuming a certain type of food or drinks, or persons who have been submitted to some form of surgical operation including anaesthesia, analgesia or narcosis, or persons in general who, for different reasons, easily get nauseous, and which nutritional drink is composed for being ingested orally, and which mainly contains proteins, carbohydrates, salts, if necessary minerals, acidifying agents, aroma, flavouring agents and vitamins, characterised in that the drink is a clear drink and has an osmolality of not more than 600 mOsmol/kg water, an energy value of not more than 85 kcal/100 ml of the drink, and a fat content which is as low as possible.

2. Nutritional drink according to claim 1, characterised in that the fat content of the drink is less than 0.2% as calculated on the defatted whey protein.

3. A nutritional drink according to claim 1 or 2, characterised in that the energy value of the drink is preferably 40-60 kcal/100 ml of the drink.

4. A nutritional drink according to any of claims 1-3, characterised in that the osmolality of the drink is 300-600 mOsmol/kg water or preferably 350-400 mOsmol/kg water.

5. A nutritional drink according to claims 1-4, characterised in that the nutritional drink has a protein content which is 0.5-5.0 g/100 ml of the drink, or preferably 1.5-3.0 g/100 ml of the drink.

6. A nutritional drink according to any of the preceding claims, characterised in that the proteins are constituted by intact protein from defatted whey protein, hydrolysed protein, other types of defatted milk proteins, protein from soy, rice, peas, beans, e.g. soy beans and from other protein sources, which proteins can be intact or hydrolysed, used separately of in combination with each other.

7. A nutritional drink according to any of the preceding claims, characterised in that the carbohydrate content of the drink is 6-20 g/100 ml of the drink.

8. A nutritional drink according to any of the preceding claims, characterised in that the carbohydrates are chosen from the group of carbohydrates containing saccharose, maltodextrin, glucose, glucose syrup, fructose, fructose syrup, saccharose and starch, and other known carbohydrate sources.

9. A nutritional drink according to any of the preceding claims, characterised in that the drink contains an amount of mineral salts which, together with acidifying agents, give a pH-value in the final drink of between pH 3 and pH 6.

10. A nutritional drink according to claim 9, characterised in that the drink contains acidifying agents that give a pH-value of pH 3-6, or preferably pH 3.2-3.7.

11. A nutritional drink according to claim 9 or 10, characterised in that the minerals are constitutes by sodium, potassium and phosphorous, and if desired calcium, iron, magnesium and zinc.

12. A nutritional drink according to claim 11, characterised in that the sodium is present in an amount of 30-50 mg/100 ml of the drink, potassium in an amount of 20-30 mg/100 ml of the drink and phosphorous in an amount of 40-60 mg/100 ml of the drink.

13. A nutritional drink according to any of the preceding claims, characterised in that the acidifying agent is chosen from the group of acids containing lactic acid, citric acid, phosphoric acid and/or fruit juices, or a combination of acids and/or fruit juices.

14. A nutritional drink according to any of the preceding claims, characterised in that the drink further contains aromas such as fruit or berry aroma.
